(19) United States
(12) Patent Application Publication
(10) Pub. No.: US 2004/0193434 A1
(43) Pub. Date: Sep. 30, 2004

(54) Distribution system for goods

(76) Inventors: Anton Vormair, Grieskirchen (AT); Roland Unger, Wolfau (AT)

Correspondence Address: WILLIAM COLLARD, COLLARD & ROE, P.C., 1077 NORTHERN BOULEVARD, ROSLYN, NY, 11576, US

(21) Appl. No.: 10/483,468

(22) PCT Filed: Jun. 19, 2002
(86) PCT No.: PCT/AT02/00177

(30) Foreign Application Priority Data
Jul. 13, 2001 (AT) 1093/01

(51) Int. Cl. G06F 17/60

(52) U.S. Cl. 705/1

(57) ABSTRACT

A distribution system for goods is described comprising distribution stations (10) which comprise lockers (1) for receiving goods which can be actuated via a control unit (2) and a computer unit (3) which is connected to the control unit (2), to an input and display device (4) and to a memory (9) for receiver and authorization codes. In order to provide advantageous distribution conditions it is proposed that the mutually coupled computer units (3) of the individual distribution stations (10) which are locally separated from each other are provided on the one hand with a printer (6) each for machine-readable receiver addresses from an address memory (5) loadable via an input and display device (4) as well as a reading device (7) for receiver addresses attachable to such goods and on the other hand with a program memory (13) each for determining the path of the goods between a dispatch and a target station (A, E) depending on the receiver address, the available lockers of the distribution stations (10) and transport sections, if any, and that the distribution stations (10) comprise a transmitting and receiving unit (12) connected to the computer unit (3) for choosing at least one address chosen on the basis of the determined path of goods from the stored addresses concerning an authorized freight agent (14) for the transportation of goods or the receiver address.

### 1. FIELD OF THE INVENTION

The invention relates to a distribution system for goods with distribution stations which comprise lockers for receiving goods which can be actuated via a control unit and a computer unit which is connected to the control unit, to an input and display device and a memory for receiver and authorization codes.

### 2. DESCRIPTION OF THE PRIOR ART

In order to enable the collection of ordered goods independent of opening times, sales systems are known (EP 0 396 139 A1, EP 0 531 942 A2) which comprise distribution stations with lockers in which the ordered goods are placed by the merchant and then are collected by a customer preferably by cashless payment. For this purpose the lockers can be actuated via a control unit by a computer unit which checks on the one hand the merchant authorization and on the other hand the access authorization of a receiver of merchandise stored in the locker on the basis of a stored receiver code. In order to fulfill the order which can be placed for example via an input and display device of the computer unit of such a distribution station when the respective merchants are connected to such a computer unit, the merchant registering via the input and display device will be allocated a free locker for the delivered goods, this being with the requirement to enter the data necessary for collecting the goods such as receiver code and price. The allocated locker will then be opened on the basis of this data input, so that the ordered goods can be stored in the locker. To collect the goods the receiver is asked to enter the receiver code and the data required for cashless payment before the locker allocated to the entered receiver code is indicated together with the price for the merchandise. The indicated locker is then opened by means of the control unit via a confirmation on the receiver side in order to remove the paid goods.

These known sales systems can only be used in locally limited areas because the users only have one available distribution station.

### SUMMARY OF THE INVENTION

The invention is thus based on the object of providing a distribution system for goods with mutually locally separated distribution stations between which goods of different senders can be sent to different receivers, namely without any limitations on the use of the system.

This object is achieved by the invention in such a way that the mutually coupled computer units of the individual distribution stations which are locally separated from each other are provided on the one hand with a printer each for machine-readable receiver addresses from an address memory loadable via an input and display device as well as a reading device for receiver addresses attachable to such goods and on the other hand with a program memory each for determining the path of the goods between a dispatch and a target station depending on the receiver address, the available lockers of the distribution stations and conveying sections, if any, and that the distribution stations comprise a sending and receiving unit connected to the computer unit for choosing at least one address chosen on the basis of the determined path of goods from the stored addresses concerning an authorized freight agent for the transportation of goods or the receiver address.

As a result of the networking of the individual distribution stations as provided by these measures, it is possible, by including freight agents for the transportation of goods, to provide an advantageous distribution system which meets all requirements and which can be used substantially without any limitations for goods traffic. For this purpose the provision of all data required for the dispatch of goods (and especially the receiver address) is demanded before a free locker is displayed and is opened for the input of goods. A printer which is provided in each distribution station is used to print the data required for the goods traffic, but at least the receiver address, in a machine-readable form, preferably on stickers which are attached to the goods. After the printout of a dispatch record the dispatch process can be regarded as completed.

A program memory is used for determining the path of the goods between a dispatch and a target station depending on the entered receiver address. The system not only considers the offer of lockers in the individual distribution stations, but also any predetermined conveying sections allocated to individual freight agents. Following the determination of the respective path of goods, a free locker is booked in the target station or a provided intermediate station, so that overstocking a distribution station can be excluded. Moreover, the freight agents provided for the determined path of goods are notified via a sending and receiving unit connected to the computer unit about the readiness of merchandise to be transported, which can thus be collected by a freight agent accepting the transport order. On the basis of their authorization code the computer unit checks in the dispatch station whether merchandise is reserved for the freight agent and initiates the display of the respective locker and its opening. The freight agent removes the goods from the locker and initiates a renewed printout of the machine-readable receiver address in the case that no receiver address has been attached to the merchandise to be accepted. After the closure of the opened locker an acceptance confirmation can be sent to the freight agent. The freight agent who has been notified via the sending and receiving unit about the target station or intermediate station to which the merchandise is to be supplied now transports the goods to the stated target or intermediate station where they enter the receiver address on the merchandise via a reading device once the freight agent has proved their authorization via the authorization code. Based on the read receiver address, the locker reserved for the merchandise is indicated and opened in order to receive the goods. The acceptance of merchandise which is completed by the closure of the locker produces a triggering of the sending and receiving unit via the computer unit. In the case of the storage in an intermediate station, the freight agents responsible for the next conveying section are notified in order to ensure the further transport of the goods in the manner as described above. In the target station, however, the receiver is selected on the basis of the receiver address as entered by the dispatcher and the receiver is notified that merchandise is ready for collection. The goods can then be collected from the indicated distribution station with the help of a respective receiver code which can also be transmitted together with the notification. Since all distribution stations of the distribution system are configured in the same way, a high amount of functional stability is achieved for the distribution system, because even in the case of the failure of one distribution station the distribution system can be continued to be used via the other distribution stations.

In order to enable the identification of goods not only via the receiver address it is recommended to ensure an additional identification of the merchandise. For this purpose the computer units can be provided with encoders for goods to be stored in free lockers, with the transmitting and receiving units at least transmitting the codes allocated to the goods in the respective distribution stations to the chosen freight agents and/or receivers, so that the access to the goods stored in a distribution station is only possible with a code which is only produced upon storing the goods in said distribution stations. Such a code can easily be produced from the address of the distribution station, the number of the used locker and the time of storing the goods for example. If the code of a merchandise identifier as issued by the encoder of the dispatch station of a merchandise forms a merchandise identifier for all distribution stations, the path of the merchandise can advantageously be traced on the basis of this code. Moreover, in the case of a separate transfer of the codes produced by the dispatch station and the target station to the receiver address it is possible to exclude any unlawful removal of merchandise with a high amount of probability.

### BRIEF DESCRIPTION OF THE DRAWINGS

The subject matter of the invention is shown in closer detail by way of an example in the drawings, wherein:

FIG. 1 shows a distribution station of a distribution system in accordance with the invention for merchandise in schematic block diagram, and

FIG. 2 shows a block diagram of a distribution system composed of such distribution stations.

### DESCRIPTION OF THE PREFERRED EMBODIMENTS

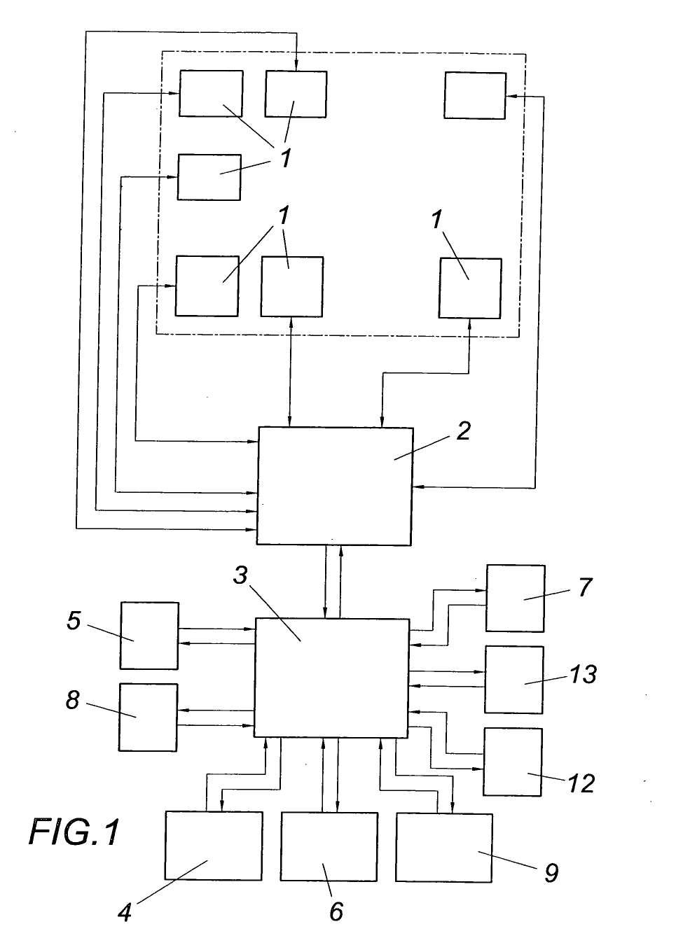

According to FIG. 1, the lockers 1 of a distribution station are triggered via a common control unit 2 which is connected with a superset computer unit 3. Said computer unit 3 can be actuated through an input and display device 4 in order to dispatch goods for a certain receiver. For this purpose it is necessary to enter the data required for the dispatch of the merchandise. In addition to the receiver address these will especially be data on the sender, the manner of dispatch and the mode of payment. Based on the entered data a free locker 1 which is suitable for the chosen dispatch mode will be selected and displayed. Moreover, the entered receiver address is stored in an address memory 5 from which it is output for printout in a machine-readable form on a printer 6 via the computer unit 3. The printer 6 thus provides a sticker with a machine-readable receiver address for attachment on the merchandise. For the purpose of storing merchandise that is already provided with a machine-readable receiver address, there is a reading device 7 for receiver addresses that can be attached to the merchandise. Following the storage of the merchandise in a locker 1, said merchandise is associated with a code which is produced in an encoder 8 from the respective station address, locker number and the time of the storing of the merchandise. This code to which the receiver address can be allocated is administrated in an identifier memory 9.

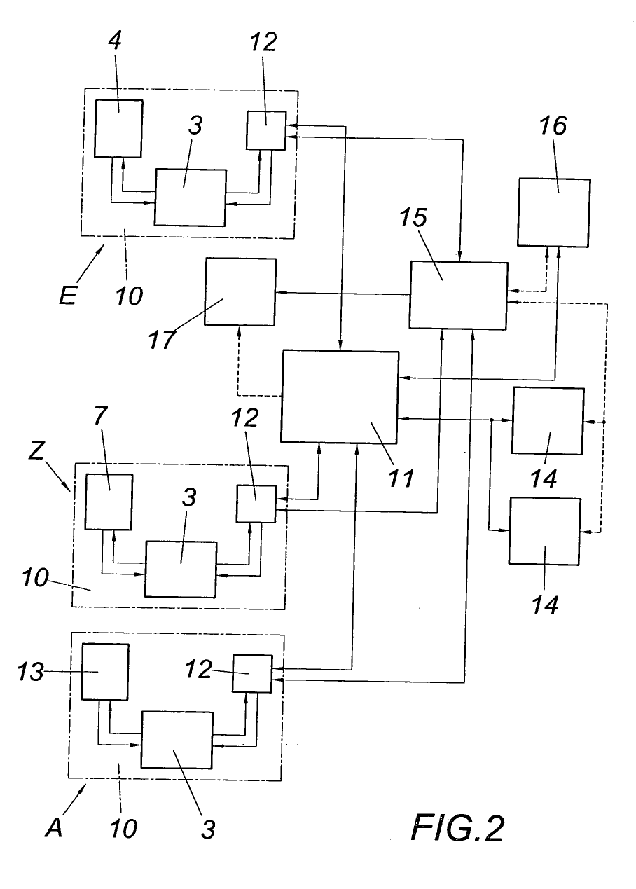

As is shown in FIG. 2, several distribution stations 10 are provided which are configured in a substantially similar way and which are mutually connected through a network 11. For this purpose the computer units 3 of the distribution stations 10 are equipped with respective transmitting and receiving units 12. A path of goods from the respective dispatch station to a target station can be determined in the individual distribution stations 10 by optional use of intermediate stations with the help of a program memory 13 from the entered receiver address on the basis of the existing distribution stations 10. When this path of goods between the individual distribution stations 10 is determined, it is possible to take into account the respective offer of free lockers. The transportation of goods between the distribution stations 10 is carried out by the freight agents who under certain circumstances may only be authorized to carry out the transportation of goods in certain transport sections, so that the respective path of goods from the dispatch station to the target station needs to consider such a breakdown of the total path into transport sections by defining certain intermediate stations. The definition of intermediate stations may also become necessary as a result of the type of dispatch, e.g. when a certain temperature requirement is demanded for the goods to be transported. Since as a consequence of the networking of the individual distribution stations 10 the respective dispatch station is able to query information on the definition of the path of goods from the target station or optionally from the intermediate stations, it is possible to define the respective path of goods via the program memory in order to book a locker 1 for receiving goods in the distribution stations situated on said path of goods.

It is assumed according to the embodiment according to FIG. 2 that one of the distribution stations 10 is used as a dispatch station A in which the path of goods is defined on the basis of the intended transport sections and offers of available lockers after the respective data entry on the basis of the stored data via the program memory 13. Said path of transportation to the target station E extends through an intermediate station Z. As a result of the defined path of goods, the lockers 1 required for receiving the goods are booked both in the intermediate station Z as well as in the target station E. Moreover, the addresses of the freight agents 14 are selected through the transmitting and receiving units 12, which freight agents are authorized to conduct the transport of goods between the dispatch station A and the intermediate station Z. The addresses of said freight agents 14 are stored in the address memory of each distribution station 10. The network 11 can be used to select the freight agents 14, as is shown in FIG. 2. It is also possible to use a separate network 15 for connecting the individual distribution stations 10 with the freight agents 14, as is indicated in FIG. 2 with the broken line. Once one of the selected freight agents 14 confirms the acceptance of the order for the transport of goods from the dispatch station A to the intermediate station Z, the order will be blocked for the other freight agents 14, so that double bookings can be excluded. The transmitted order confirmation is used to inform the stations A and Z about the freight agent 14 who as accepted the order. The freight agent 14 must confirm his or her entitlement via a predetermined authorization code which is stored in the identifier memory 9 for the individual freight agents 14. The freight agent 14 who accepts the offer now collects the merchandise from dispatch station A by entering their authorization code via the input and display device 4, whereupon the lockers 1 are indicated and opened in which the merchandise is situated to be collected by said freight agent 14. The freight agent 14 checks whether the machine-readable receiver address has been properly attached to the goods and, if it is missing, initiates a renewed printout of such a receiver address contained in the address memory 5 via the printer 6. With the acceptance of the goods and the closure of the respective locker 1, an acceptance voucher is printed out by the printer 6 for the freight agent 14, who will now transport the accepted goods to the intermediate station Z where they must report again with the help of the authorization code. The goods to be accepted are identified via the reader device 7 in the intermediate station 7 on the basis of the receiver address which preferably comprises the code produced in dispatch station A for the merchandise in order to indicate and open the locker 1 reserved for the respective merchandise. The acceptance process is completed after the storage of the goods in the locker and the closure of the locker. An additional code is assigned to the accepted merchandise through the encoder 8 of intermediate station Z, which code is relevant for the collection of the merchandise. After the goods have been received by the intermediate station Z, a freight agent 16 is selected by the transmitting and receiving unit 12 of the intermediate station Z via the network 11 or network 15, which freight agent is responsible for the transport section between the intermediate station Z and the target station E. The selected freight agent 16 collects the goods from the intermediate station Z in the manner already described above after accepting the order and delivers them to the target station E where the acceptance of goods is performed in the manner as in all previous distribution stations 10. In contrast to the intermediate station Z, the receiver 17 is contacted according to the receiver address via the transmitting and receiving unit 12 of the target station E, e.g. via the network 15 for radio telephony. Contacting the receiver 17 can naturally also occur via the network 11 if the receiver 17 is hooked up to network 11.

The receiver 17 who is notified in this manner about the arrival of merchandise destined for him or her receives a receiver code with this notification which corresponds to the code generated in the target station E by the encoder 8. In order to increase security, the receiver 17 can additionally be informed about the code allocated to the merchandise in the dispatch station A, namely preferably in a separate transmission path, so that the collection of the merchandise stored in a locker 1 of the target station E is only possible by the input of the codes allocated to the goods in the dispatch station A and in the target station E. After the input of the codes sent to receiver 17 via the input and display device 4 of target station E, the receiver 17 is indicated the locker 1 which contains the merchandise and this locker is opened, as a result of which the merchandise is removed from the distribution system. It is obvious that cashless payment can be provided in connection with the described distribution system in the known manner in order to make the transportation of goods and the release of goods dependent upon the due and proper payment of the merchandise.

Goods can also be distributed via the individual distribution stations 10 even without transportation between the distribution stations as long as the dispatch station A is the same as the target station E because in this case it is not the freight agent who is informed by the dispatch station A but the receiver 17 instead.

1. A distribution system for goods with distribution stations which comprise lockers for receiving goods which can be actuated via a control unit and a computer unit which is connected to the control unit, to an input and display device and to a memory for receiver and authorization codes, characterized in that the mutually coupled computer units (3) of the individual distribution stations (10) which are locally separated from each other are provided on the one hand with a printer (6) each for machine-readable receiver addresses from an address memory (5) loadable via an input and display device (4) as well as a reading device (7) for receiver addresses attachable to such goods and on the other hand with a program memory (13) each for determining the path of the goods between a dispatch and a target station (A, E) depending on the receiver address, the available lockers of the distribution stations (10) and transport sections, if any, and that the distribution stations (10) comprise a transmitting and receiving unit (12) connected to the computer unit for choosing at least one address chosen on the basis of the determined path of goods from the stored addresses concerning an authorized freight agent (14) for the transportation of goods or the receiver address.

2. A distribution system as claimed in claim 1, characterized in that the computer units (3) are provided with encoders (8) for the merchandise to be stored in free lockers (1) and that the transmitting and receiving units (12) send at least the codes allocated to the merchandise in the respective distribution stations (10) to the chosen freight agents (14) and/or the receivers (17).

3. A distribution system as claimed in claim 2, characterized in that the code issued by the encoder (8) of the dispatch station (1) of a merchandise forms a merchandise identifier for all distribution stations (10).
